(19) United States
(12) Patent Application Publication
(10) Pub. No.: US 2026/0112542 A1
(43) Pub. Date: Apr. 23, 2026

(54) ARRAY TYPE MULTI-LAYER CERAMIC CAPACITOR

(71) Applicant: YAGEO CORPORATION, Kaohsiung City (TW)

(72) Inventors: Ming-Chun WU, Kaohsiung City (TW); Hsin-Yen LIU, Kaohsiung City (TW); Hui-Yi WEN, Kaohsiung City (TW)

(21) Appl. No.: 19/002,540

(22) Filed: Dec. 26, 2024

(30) Foreign Application Priority Data
Oct. 22, 2024 (TW) 113140110

(51) Int. Cl. H01G 4/38; H01G 4/012; H01G 4/232; H01G 4/30

(52) U.S. Cl. CPC H01G 4/385; H01G 4/012; H01G 4/232; H01G 4/30

(57) ABSTRACT

An array type multi-layer ceramic capacitor includes a multi-layer brick and terminal electrode pairs. The multi-layer brick includes a ceramic body and internal electrode sets. The ceramic body has upper and surfaces, and first and second end surfaces. Each internal electrode set includes plural alternating first and second internal electrodes. The first and second internal electrodes respectively extend from the first and second end surfaces. Each first and second internal electrode includes first and second portions. The first portion includes first to fourth side surfaces. The first to third side surfaces are exposed on the upper surface, the first or second end surface, and the lower surface. The terminal electrode pairs are correspondingly disposed on the internal electrode sets. Each terminal electrode pair includes first and second terminal electrodes that cover the first to third side surfaces of the first portions of the first and second internal electrodes respectively.

CROSS - REFERENCE TO R ELATED A PPLICATIONS

This application claims priority to Taiwan Application Serial Number 113140110, filed October 22, 2024, which is herein incorporated by reference in its entirety.

### BACKGROUND

### Field of Invention

The present disclosure relates to a technology for manufacturing a passive device, and more particularly, to an array type multi-layer ceramic capacitor.

### Description of Related Art

A multi-layer ceramic capacitor may include a multi-layer brick and two terminal electrodes covering two end surfaces of the multi-layer brick. Currently, most of the terminal electrodes are formed by first dipping the two end surfaces of the multi-layer brick into molten metal to form a first layer of metal, and then plating other metal layers that facilitate welding. However, when such a terminal electrode manufacturing technology is applied to manufacture an array type multi-layer ceramic capacitor, it cannot meet the miniaturization needs of the array type multi-layer ceramic capacitor due to the limitation of the copper paste dipping process.

In addition, the terminal electrode formed by using this method has high surface roughness and poor thickness uniformity. When the multi-layer ceramic capacitors are embedded in a package structure, the high surface roughness and poor thickness uniformity of the terminal electrodes result in reduced connection reliability between the terminal electrodes and vias that connect the terminal electrodes to circuits in other layers of the package structure, and thus decreasing the packaging yield.

### SUMMARY

Therefore, one objective of the present disclosure is to provide an array type multi-layer ceramic capacitor, which is not limited by the traditional copper paste dipping process, and can simultaneously form terminal electrodes of capacitor units of the array type multi-layer ceramic capacitor, thereby achieving the miniaturization of the array type multi-layer ceramic capacitor.

According to the above objective, the present disclosure provides an array type multi-layer ceramic capacitor. The array type multi-layer ceramic capacitor includes a multi-layer brick and plural terminal electrode pairs. The multi-layer brick includes a ceramic body and plural internal electrode sets. The ceramic body has an upper surface and a lower surface, and a first end surface and a second end surface that are opposite to each other. The first end surface and the second end surface are located between the upper surface and the lower surface. The internal electrode sets are embedded in the ceramic body and are physically separated from each other. Each of the internal electrode sets includes plural first internal electrodes and plural second internal electrodes. In each of the internal electrode sets, the first internal electrodes and the second internal electrodes alternate with each other and are physically separated from each other. The first internal electrodes extend from the first end surface toward the second end surface and are spaced apart from the second end surface. The second internal electrodes extend from the second end surface toward the first end surface and are spaced apart from the first end surface. Each of the first internal electrodes and the second internal electrodes includes a first portion and a second portion. The first portion includes a first side surface, a second side surface, a third side surface, and a fourth side surface connected in sequence. The first side surface, the second side surface, and the third side surface are respectively exposed on the upper surface, the first end surface or the second end surface, and the lower surface. The second portion is connected to the fourth side surface of the first portion, and the second portion is completely embedded in the ceramic body without being exposed. The terminal electrode pairs are correspondingly disposed on the internal electrode sets and are spaced apart from each other. Each of the terminal electrode pairs includes a first terminal electrode and a second terminal electrode. The first terminal electrode extends to cover the first side surfaces, the second side surfaces, and the third side surfaces of the first portions of the first internal electrodes of the corresponding internal electrode set. The second terminal electrode extends to cover the first side surfaces, the second side surfaces, and the third side surfaces of the first portions of the second internal electrodes.

According to one embodiment of the present disclosure, numbers of the first internal electrodes of the internal electrode sets are the same, and numbers of the second internal electrodes of the internal electrode sets are the same.

According to one embodiment of the present disclosure, numbers of the first internal electrodes of the internal electrode sets are different from each other, and numbers of the second internal electrodes of the internal electrode sets are different from each other.

According to one embodiment of the present disclosure, numbers of the first internal electrodes in a portion of the internal electrode sets are the same, numbers of the second internal electrodes in the portion of the internal electrode sets are the same, and a number of the first internal electrodes and a number of the second internal electrodes in each of the other portion of the internal electrode sets are different from the portion of the internal electrode sets.

According to one embodiment of the present disclosure, the internal electrode sets are divided into a plurality of groups, and in each of the groups, numbers of the first internal electrodes of the internal electrode sets are the same and numbers of the second internal electrodes of the internal electrode sets are the same.

According to one embodiment of the present disclosure, each of the internal electrode sets of each of the groups and each of the internal electrode sets of any other of the groups include different numbers of the first internal electrodes and different numbers of the second internal electrodes.

According to one embodiment of the present disclosure, each of the first terminal electrode and the second terminal electrode of each of the terminal electrode pairs comprises an electroplated copper structure.

According to one embodiment of the present disclosure, each of the first internal electrodes and the second internal electrodes is in a T-like shape.

According to one embodiment of the present disclosure, each of the internal electrode sets, the corresponding terminal electrode pairs, and portions of the ceramic body between the corresponding terminal electrode pairs form a capacitor unit, and structures of the capacitor units are the same as each other.

According to one embodiment of the present disclosure, each of the internal electrode sets, the corresponding terminal electrode pairs, and portions of the ceramic body between the corresponding terminal electrode pairs form a capacitor unit, and structures of the capacitor units are different from each other.

According to the above embodiments, it can be known that the array type multi-layer ceramic capacitor of the present disclosure includes plural internal electrode sets, and three side surfaces of the first portion of each of the first internal electrodes and the second internal electrodes of each of the internal electrode sets are exposed on the upper surface, the end surfaces, and the lower surface of the ceramic body. Therefore, based on the exposed portions of each of the internal electrode sets, terminal electrodes can be grown on the two end surfaces of the ceramic body and the areas of the upper surface and the lower surface adjacent to the two end surfaces by electroplating. The terminal electrodes of each of the internal electrode sets are formed by electroplating, such that the terminal electrodes of the capacitor units of the array type multi-layer ceramic capacitor can be formed simultaneously, thereby achieving the miniaturization of the array type multi-layer ceramic capacitor. In addition, the terminal electrodes grown by electroplating has low surface roughness and uniform thickness, which is beneficial to the application of the array type multi-layer ceramic capacitor in an embedded packaging structure.

### BRIEF DESCRIPTION OF THE DRAWINGS

Aspects of the present disclosure are best understood from the following detailed description in conjunction with the accompanying figures. It is noted that in accordance with the standard practice in the industry, various features are not drawn to scale. In fact, dimensions of the various features can be arbitrarily increased or reduced for clarity of discussion.

FIG. 1 is a three-dimensional schematic diagram of an array type multi-layer ceramic capacitor in accordance with a first embodiment of the present disclosure.

FIG. 2 is a schematic side view of an array type multi-layer ceramic capacitor in accordance with the first embodiment of the present disclosure.

FIG. 3 is a three-dimensional schematic diagram of a multi-layer brick of an array type multi-layer ceramic capacitor in accordance with the first embodiment of the present disclosure.

FIG. 4 is a schematic perspective view of a multi-layer brick of an array type multi-layer ceramic capacitor in accordance with the first embodiment of the present disclosure.

FIG. 5 is a schematic side view of a first internal electrode in accordance with the first embodiment of the present disclosure.

FIG. 6 is a schematic side view of a second internal electrode in accordance with the first embodiment of the present disclosure.

FIG. 7 is a schematic top view of an array type multi-layer ceramic capacitor in accordance with a second embodiment of the present disclosure.

FIG. 8 is a schematic top view of an array type multi-layer ceramic capacitor in accordance with a third embodiment of the present disclosure.

FIG. 9 is a schematic top view of an array type multi-layer ceramic capacitor in accordance with a fourth embodiment of the present disclosure.

### DETAILED DESCRIPTION

The embodiments of the present disclosure are discussed in detail below. However, it will be appreciated that the embodiments provide many applicable concepts that can be implemented in various specific contents. The embodiments discussed and disclosed are for illustrative purposes only and are not intended to limit the scope of the present disclosure. All of the embodiments of the present disclosure disclose various different features, and these features may be implemented separately or in combination as desired.

In addition, the terms "first", "second", and the like, as used herein, are not intended to mean a sequence or order, and are merely used to distinguish elements or operations described in the same technical terms.

The spatial relationship between two elements described in the present disclosure applies not only to the orientation depicted in the drawings, but also to the orientations not represented by the drawings, such as the orientation of the inversion. Moreover, the terms "connected", "electrically connected", or the like between two components referred to in the present disclosure are not limited to the direct connection or electrical connection of the two components, and may also include indirect connection or electrical connection as required.

The present disclosure can integrate plural capacitor units in a multi-layer brick according to various application requirements. The capacitor units may have the same capacitance value or different capacitance values; or some of the capacitor units have the same capacitance value, while other capacitor units have different capacitance values.

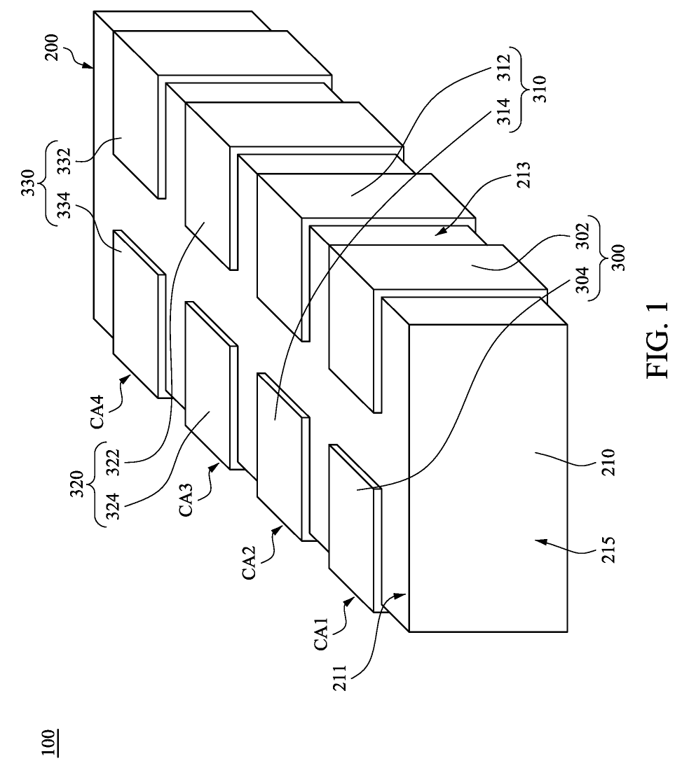

Referring to FIG. 1 to FIG. 4, FIG. 1 to FIG. 4 respectively illustrate a three-dimensional schematic diagram and a schematic side view of an array type multi-layer ceramic capacitor 100, and a three-dimensional schematic diagram and a schematic perspective view of a multi-layer brick 200 of the array type multi-layer ceramic capacitor 100 in accordance with the first embodiment of the present disclosure. The array type multi-layer ceramic capacitor 100 is formed by integrating plural capacitor units, and the capacitor units are arranged in an array. The array type multi-layer ceramic capacitor 100 mainly includes a multi-layer brick 200 and plural terminal electrode pairs 300, 310, 320, and 330.

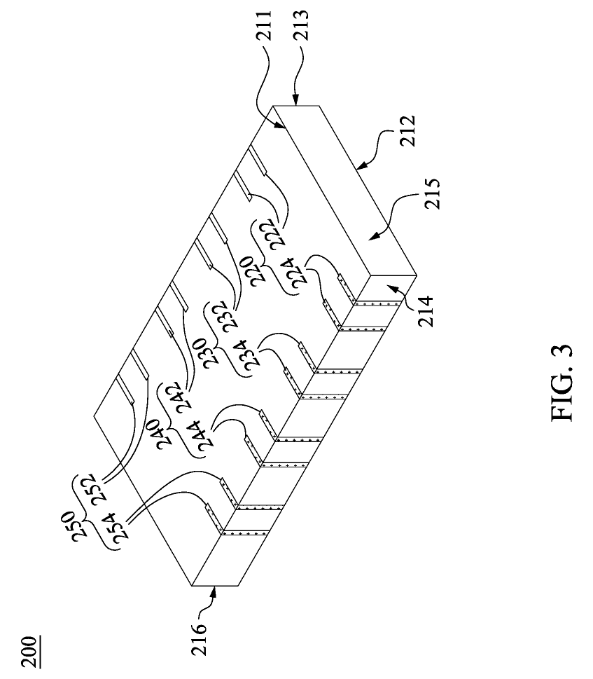

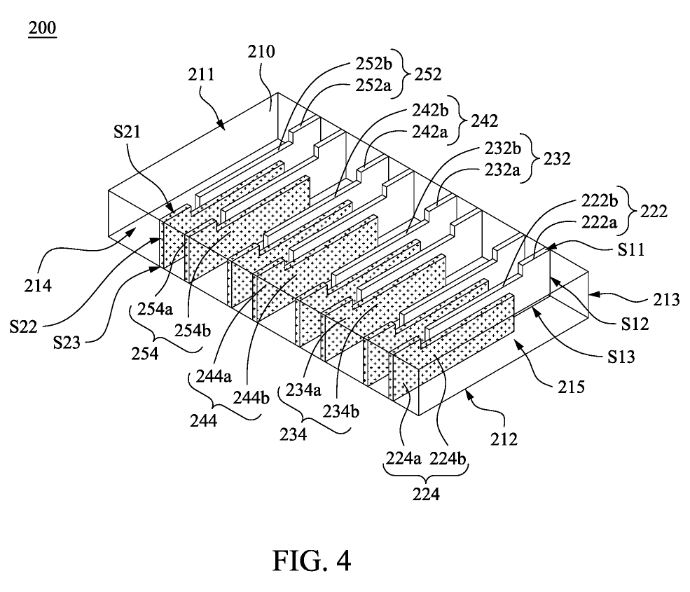

The multi-layer brick 200 may be a cubic structure, such as a cuboid or a cube. A shape of the multi-layer bricks 200 may be designed according to product requirements, and the present disclosure is not limited thereto. In the example shown in FIG. 1, the multi-layer brick 200 is a cuboid. As shown in FIG. 3 and FIG. 4, the multi-layer brick 200 may mainly include a ceramic body 210 and plural internal electrode sets 220, 230, 240, and 250. The internal electrode sets 220, 230, 240, and 250 are embedded in the ceramic body 210 and are physically separated from each other. The internal electrode set 220 includes plural first internal electrodes 222 and plural second internal electrodes 224. The internal electrode set 230 includes plural first internal electrodes 232 and plural second internal electrodes 234. The internal electrode set 240 includes plural first internal electrodes 242 and plural second internal electrodes 244. The internal electrode set 250 includes plural first internal electrodes 252 and plural second internal electrodes 254.

In the manufacturing of the multi-layer brick 200, plural ceramic green sheets can be alternately stacked with the internal electrode sets 220, 230, 240, and 250 to form a stacked structure, and then the stacked structure is sintered. Taking the internal electrode set 220 as an example, one first internal electrode 222, one ceramic green sheet, one second internal electrode 224, another ceramic green sheet, another first internal electrode 222, still another ceramic green sheet, another second internal electrode 224, and yet another ceramic green sheet may be sequentially stacked on further another ceramic green sheet. Subsequently, according to the stacking method of the internal electrode set 220 and the ceramic green sheets, the ceramic green sheets, the first internal electrodes 232 and the second internal electrodes 234 of the internal electrode set 230, the first internal electrodes 242 and the second internal electrodes 244 of the internal electrode set 240, and the first internal electrodes 252 and the second internal electrodes 254 of the internal electrode set 250 are sequentially stacked. The ceramic body 210 is formed by sintering the ceramic green sheets.

In the example shown in FIG. 3, the ceramic body 210 is a cuboid having six surfaces. Specifically, the ceramic body 210 has an upper surface 211 and a lower surface 212, a first end surface 213 and a second end surface 214 that are opposite to each other, and a first side surface 215 and a second side surface 216 that are opposite to each other. The first end surface 213, the second end surface 214, the first side surface 215, and the second side surface 216 are all located between the upper surface 211 and the lower surface 212. In addition, the first side surface 215 and the second side surface 216 are located between the first end surface 213 and the second end surface 214.

As shown in FIG. 4, each of the first internal electrodes 222, 232, 242, and 252 and the second internal electrodes 224, 234, 244, and 254 is a sheet structure. Each of the first internal electrodes 222, 232, 242, and 252 extends from the first end surface 213 of the ceramic body 210 toward the second end surface 214 and is spaced apart from the second end surface 214. Each of the second internal electrodes 224, 234, 244, and 254 extends from the second end surface 214 of the ceramic body 210 toward the first end surface 213 and is spaced apart from the first end surface 213. Numbers of the first internal electrodes 222, 232, 242, and 252 may be the same as or different from numbers of the second internal electrodes 224, 234, 244, and 254, respectively. For example, the numbers of the first internal electrodes 222, 232, 242, and 252 may be respectively one greater than the numbers of the second internal electrodes 224, 234, 244, and 254, and vice versa.

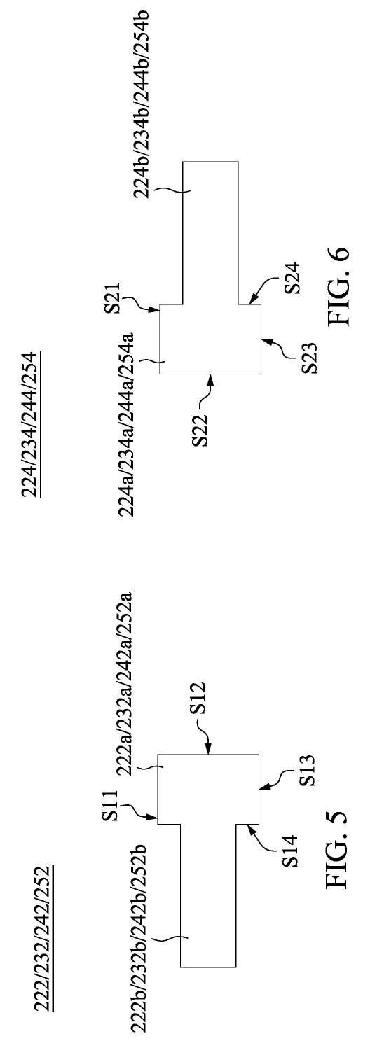

Referring to FIG. 4 and FIG. 5 simultaneously, FIG. 5 is a schematic side view of first internal electrodes 222, 232, 242, and 252 in accordance with the first embodiment of the present disclosure. Each of the first internal electrodes 222 of the internal electrode set 220 includes a first portion 222a and a second portion 222b that are connected to each other. Each of the first internal electrodes 232 of the internal electrode set 230 includes a first portion 232a and a second portion 232b that are connected to each other. Each of the first internal electrodes 242 of the internal electrode set 240 includes a first portion 242a and a second portion 242b that are connected to each other. Each of the first internal electrodes 252 of the internal electrode set 250 includes a first portion 252a and a second portion 252b that are connected to each other.

The first portions 222a, 232a, 242a, and 252a may be square or rectangular sheet structures. Each of the first portions 222a, 232a, 242a, and 252a includes a first side surface S11, a second side surface S12, a third side surface S13, and a fourth side surface S14 connected in sequence. The first side surface S11, the second side surface S12, and the third side surface S13 are respectively located in the upper surface 211, the first end surface 213, and the lower surface 212 of the ceramic body 210. Therefore, as shown in FIG. 4, the first side surface S11, the second side surface S12, and the third side surface S13 are respectively exposed on the upper surface 211, the first end surface 213, and the lower surface 212 of the ceramic body 210.

The second portions 222b, 232b, 242b, and 252b are respectively connected to the fourth side surfaces S14 of the first portions 222a, 232a, 242a, and 252a. The second portions 222b, 232b, 242b, and 252b respectively extend from the fourth side surfaces S14 of the first portions 222a, 232a, 242a, and 252a toward the second end surface 214, but are spaced apart from the second end surface 214. The second portions 222b, 232b, 242b, and 252b may all be square or rectangular sheet structures. Heights of the second portions 222b, 232b, 242b, and 252b are respectively smaller than heights of the first portions 222a, 232a, 242a, and 252a to which they are connected, and the second portions 222b, 232b, 242b, and 252b are completely embedded in the ceramic body 210 without being exposed.

Referring to FIG. 4 and FIG. 6 simultaneously, FIG. 6 is a schematic side view of second internal electrodes 224, 234, 244, and 254 in accordance with the first embodiment of the present disclosure. Each of the second internal electrodes 224 of the internal electrode set 220 includes a first portion 224a and a second portion 224b that are connected to each other. Each of the second internal electrodes 234 of the internal electrode set 230 includes a first portion 234a and a second portion 234b that are connected to each other. Each of the second internal electrodes 244 of the internal electrode set 240 includes a first portion 244a and a second portion 244b that are connected to each other. Each of the second internal electrodes 254 of the internal electrode set 250 includes a first portion 254a and a second portion 254b that are connected to each other.

Similarly, the first portions 224a, 234a, 244a, and 254a may be square or rectangular sheet structures. Each of the first portions 224a, 234a, 244a, and 254a includes a first side surface S21, a second side surface S22, a third side surface S23, and a fourth side surface S24 connected in sequence. The first side surface S21, the second side surface S22, and the third side surface S23 are respectively located in the upper surface 211, the second end surface 214, and the lower surface 212 of the ceramic body 210. Therefore, as shown in FIG. 4, the first side surface S21, the second side surface S22, and the third side surface S23 are respectively exposed on the upper surface 211, the second end surface 214, and the lower surface 212 of the ceramic body 210.

The second portions 224b, 234b, 244b, and 254b are respectively connected to the fourth side surfaces S24 of the first portions 224a, 234a, 244a, and 254a. The second portions 224b, 234b, 244b, and 254b respectively extend from the fourth side surfaces S24 of the first portions 224a, 234a, 244a, and 254a toward the first end surface 213, but are spaced from the first end surface 213. The second portions 224b, 234b, 244b, and 254b may all be square or rectangular sheet structures. The second portions 224b, 234b, 244b, and 254b are respectively narrower than the first portions 224a, 234a, 244a, and 254a to which they are connected, and the second portions 224b, 234b, 244b, and 254b are completely embedded in the ceramic body 210 without being exposed.

In some examples, the first internal electrodes 222, 232, 242, and 252 are respectively mirror symmetrical to the second internal electrodes 224, 234, 244, and 254. That is, the second internal electrodes 224, 234, 244 and 254 can completely overlap the first internal electrodes 222, 232, 242 and 252 respectively after being turned over 180 degrees. However, the first internal electrodes 222, 232, 242, and 252 may be asymmetrical to the second internal electrodes 224, 234, 244, and 254 respectively, and the present disclosure is not limited thereto. In some examples, each of the first internal electrodes 222, 232, 242, and 252 and the second internal electrodes 224, 234, 244, and 254 may be in a T-like shape. In some examples, the upper surface 211 and the lower surface 212 are parallel to each other, and the first internal electrodes 222, 232, 242, and 252 and the second internal electrodes 224, 234, 244, and 254 are substantially perpendicular to the upper surface 211 and the lower surface 212. For example, materials of the first internal electrodes 222, 232, 242, and 252 and the second internal electrodes 224, 234, 244, and 254 may be copper, silver, or nickel.

In this embodiment, the internal electrode sets 220, 230, 240, and 250 include the same number of internal electrodes. Specifically, the number of the first internal electrodes 222 of the internal electrode set 220 is the same as the number of the first internal electrodes 232 of the internal electrode set 230, the number of the first internal electrodes 242 of the internal electrode set 240, and the number of the first internal electrodes 252 of the internal electrode set 250, and the number of the second internal electrodes 224 of the internal electrode set 220 is the same as the number of the second internal electrodes 234 of the internal electrode set 230, the number of the second internal electrodes 244 of the internal electrode set 240, and the number of the second internal electrodes 254 of the internal electrode set 250.

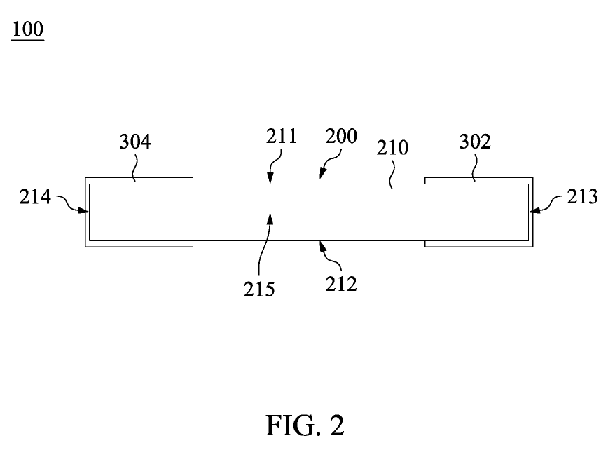

Referring to FIG. 1 and FIG. 3 simultaneously, the terminal electrode pairs 300, 310, 320, and 330 are respectively disposed on the internal electrode sets 220, 230, 240, and 250, and the terminal electrode pairs 300, 310, 320, and 330 are spaced apart from each other. The terminal electrode pair 300 includes a first terminal electrode 302 and a second terminal electrode 304. As shown in FIG. 1 and FIG. 4, the first terminal electrode 302 extends from the upper surface 211 of the ceramic body 210 through the first end surface 213 to the lower surface 212, and extends to cover the first side surfaces S11, the second side surfaces S12, and the third side surfaces S13 of the first portions 222a of the first internal electrodes 222 of the internal electrode set 220. As shown in FIG. 2, a side view of the first terminal electrode 302 is in an inverted C-like shape.

The second terminal electrode 304 extends from the upper surface 211 of the ceramic body 210 through the second end surface 214 to the lower surface 212, and extends to cover the first side surfaces S21, the second side surfaces S22, and the third side surfaces S23 of the first portions 224a of the second internal electrodes 224 of the internal electrode set 220. As shown in FIG. 2, a side view of the second terminal electrode 304 is in a C-like shape. The second terminal electrode 304 and the first terminal electrode 302 are opposite to each other and are physically separated from each other.

The terminal electrode pair 310 includes a first terminal electrode 312 and a second terminal electrode 314. The first terminal electrode 312 extends to cover the first side surfaces S11, the second side surfaces S12, and the third side surfaces S13 of the first portions 232a of the first internal electrodes 232 of the internal electrode set 230. The second terminal electrode 314 extends to cover the first side surfaces S21, the second side surfaces S22, and the third side surfaces S23 of the first portions 234a of the second internal electrodes 234 of the internal electrode set 230.

The terminal electrode pair 320 includes a first terminal electrode 322 and a second terminal electrode 324. The first terminal electrode 322 extends to cover the first side surfaces S11, the second side surfaces S12, and the third side surfaces S13 of the first portions 242a of the first internal electrodes 242 of the internal electrode set 240. The second terminal electrode 324 extends to cover the first side surfaces S21, the second side surfaces S22, and the third side surfaces S23 of the first portions 244a of the second internal electrodes 244 of the internal electrode set 240.

The terminal electrode pair 330 includes a first terminal electrode 332 and a second terminal electrode 334. The first terminal electrode 332 extends to cover the first side surfaces S11, the second side surfaces S12, and the third side surfaces S13 of the first portions 252a of the first internal electrodes 252 of the internal electrode set 250. The second terminal electrode 334 extends to cover the first side surfaces S21, the second side surfaces S22, and the third side surfaces S23 of the first portions 254a of the second internal electrodes 254 of the internal electrode set 250.

As the first terminal electrode 302, side views of the first terminal electrodes 312, 322, and 332 are in an inverted C-like shape. As the second terminal electrode 304, side views of the second terminal electrodes 314, 324, and 334 are in a C-like shape.

In some examples, each of the first terminal electrodes 302, 312, 322, and 332 and the second terminal electrodes 304, 314, 324, and 334 is a single-layer structure. In some exemplary examples, each of the first terminal electrodes 302, 312, 322, and 332 and the second terminal electrodes 304, 314, 324, and 334 is a single-layer electroplated copper structure. In other examples, each of the first terminal electrodes 302, 312, 322, and 332 and the second terminal electrodes 304, 314, 324, and 334 is a multi-layer stacked structure. For example, each of the first terminal electrodes 302, 312, 322, and 332 and the second terminal electrodes 304, 314, 324, and 334 includes an electroplated copper layer, an electroplated nickel layer, and an electroplated tin layer sequentially stacked on the ceramic body 210 to facilitate the application in other packaging methods, such as surface mount technology (SMT) packaging.

The first side surfaces S11, the second side surfaces S12, and the third side surfaces S13 of the first portions 222a, 232a, 242a, and 252a are respectively exposed on the upper surface 211, the first end surface 213, and the lower surface 212 of the ceramic body 210, and the first side surfaces S21, the second side surfaces S22, and the third side surfaces S23 of the first portions 224a, 234a, 244a, and 254a are respectively exposed on the upper surface 211, the second end surface 214, and the lower surface 212 of the ceramic body 210. Therefore, an electroplating method can be used to grow the first terminal electrodes 302, 312, 322, and 332 respectively on the first end surface 213 of the ceramic body 210 and the areas of the upper surface 211 and the lower surface 212 adjacent to the first end surface 213, and the second terminal electrodes 304, 314, 324, and 334 respectively on the second end surface 214 of the ceramic body 210 and the areas of the upper surface 211 and the lower surface 212 adjacent to the second end surface 214 based on the exposed portions of the first portions 222a, 232a, 242a and 252a and the first portions 224a, 234a, 244a and 254a.

The first terminal electrodes 302, 312, 322, and 332 and the second terminal electrodes 304, 314, 324, and 334 are formed by electroplating, such that the surface roughness of the first terminal electrodes 302, 312, 322, and 332 and the second terminal electrodes 304, 314, 324, and 334 are low and the thicknesses are uniform. Therefore, the array type multi-layer ceramic capacitor 100 is suitable for embedded packaging. In the example in which the first terminal electrodes 302, 312, 322, and 332 and the second terminal electrodes 304, 314, 324, and 334 are copper electrodes formed by electroplating, substances such as silicon, zinc, and barium will not be detected in the copper electrodes.

As shown in FIG. 1, the internal electrode set 220, the corresponding terminal electrode pair 300, and portions of the ceramic body 210 between the terminal electrode pairs 300 form a capacitor unit CA1. The internal electrode set 230, the corresponding terminal electrode pair 310, and portions of the ceramic body 210 between the terminal electrode pairs 310 form a capacitor unit CA2. The internal electrode set 240, the corresponding terminal electrode pair 320, and portions of the ceramic body 210 between the terminal electrode pairs 320 form a capacitor unit CA3. The internal electrode set 250, the corresponding terminal electrode pair 330, and portions of the ceramic body 210 between the terminal electrode pairs 330 form a capacitor unit CA4.

In some examples, structures of the capacitor units CA1, CA2, CA3, and CA4 are the same as each other. Therefore, the capacitor units CA1, CA2, CA3, and CA4 have substantially the same capacitance value. In other embodiments, the numbers of the internal electrodes in the capacitor units CA1, CA2, CA3, and CA4 are the same, but due to the difference in shapes, sizes, and/or spacing of the internal electrodes in the capacitor units CA1, CA2, CA3, and CA4, structures of the capacitor units CA1, CA2, CA3, and CA4 are different from each other. Thus, the capacitance values of the capacitor units CA1, CA2, CA3, and CA4 may be different from each other.

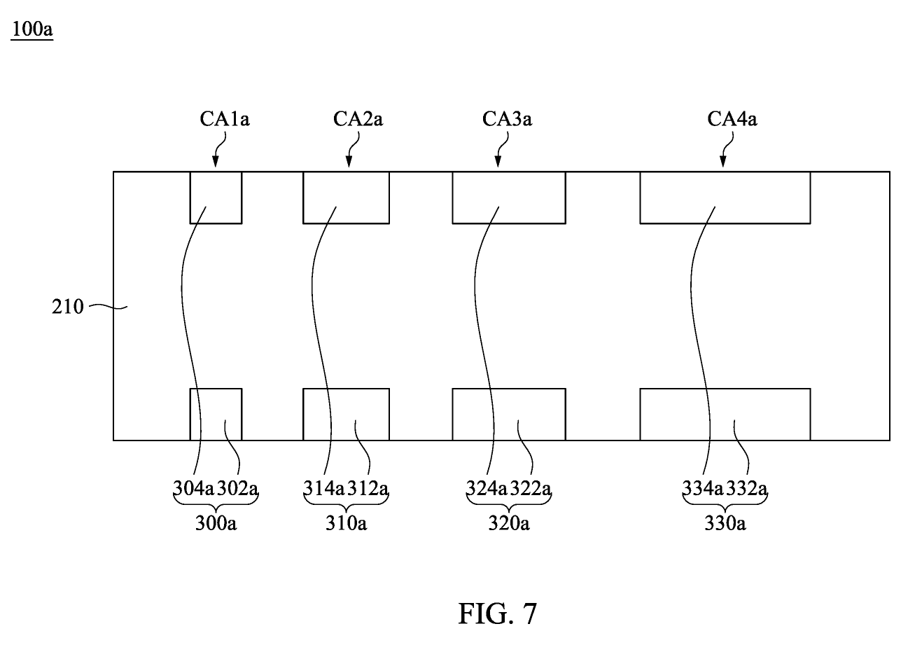

Referring to FIG. 7, FIG. 7 is a schematic top view of an array type multi-layer ceramic capacitor 100a in accordance with a second embodiment of the present disclosure. The array type multi-layer ceramic capacitor 100a is substantially the same as the array type multi-layer ceramic capacitor 100 in the above embodiment, and the difference between the array type multi-layer ceramic capacitor 100a and 100 is that numbers of internal electrodes of internal electrode sets of capacitor units CA1a, CA2a, CA3a, and CA4a of the array type multi-layer ceramic capacitor 100a are different from each other.

The capacitor unit CA1a includes an internal electrode set (not shown), a terminal electrode pair 300a including a first terminal electrode 302a and a second terminal electrode 304a, and portions of a ceramic body 210 sandwiched between the first terminal electrode 302a and the second terminal electrode 304a. The capacitor unit CA2a includes an internal electrode set (not shown), a terminal electrode pair 310a including a first terminal electrode 312a and a second terminal electrode 314a, and portions of the ceramic body 210 sandwiched between the first terminal electrode 312a and the second terminal electrode 314a. The capacitor unit CA3a includes an internal electrode set (not shown), a terminal electrode pair 320a including a first terminal electrode 322a and a second terminal electrode 324a, and portions of the ceramic body 210 sandwiched between the first terminal electrode 322a and the second terminal electrode 324a. The capacitor unit CA4a includes an internal electrode set (not shown), a terminal electrode pair 330a including a first terminal electrode 332a and a second terminal electrode 334a, and portions of the ceramic body 210 sandwiched between the first terminal electrode 332a and the second terminal electrode 334a.

The arrangements, the shapes, and the materials of the internal electrodes of the internal electrode sets of the capacitor units CA1a, CA2a, CA3a, and CA4a are the same as those of the array type multi-layer ceramic capacitor 100, and will not be repeated herein.

The internal electrode sets of the capacitor units CA1a, CA2a, CA3a, and CA4a include different numbers of the first internal electrodes and different numbers of the second internal electrodes. In addition, pitches of the first internal electrodes and the second internal electrodes of the capacitor units CA1a, CA2a, CA3a, and CA4a are substantially the same. In the present embodiment, the numbers of the first internal electrodes and the second internal electrodes of the capacitor unit CA1a are smaller than those of the capacitor unit CA2a, the numbers of the first internal electrodes and the second internal electrodes of the capacitor unit CA2a are smaller than those of the capacitor unit CA3a, and the numbers of the first internal electrodes and the second internal electrodes of the capacitor unit CA3a are smaller than those of the capacitor unit CA4a. Therefore, widths of the first terminal electrode 302a and the second terminal electrode 304a are smaller than widths of the first terminal electrode 312a and the second terminal electrode 314a, the widths of the first terminal electrode 312a and the second terminal electrode 314a are smaller than widths of the first terminal electrode 322a and the second terminal electrode 324a, and the widths of the first terminal electrode 322a and the second terminal electrode 324a are smaller than widths of the first terminal electrode 332a and the second terminal electrode 334a.

Furthermore, a capacitance value of the capacitor unit CA1a is smaller than a capacitance value of the capacitor unit CA2a, the capacitance value of the capacitor unit CA2a is smaller than a capacitance value of the capacitor unit CA3a, and the capacitance value of the capacitor unit CA3a is smaller than a capacitance value of the capacitor unit CA4a.

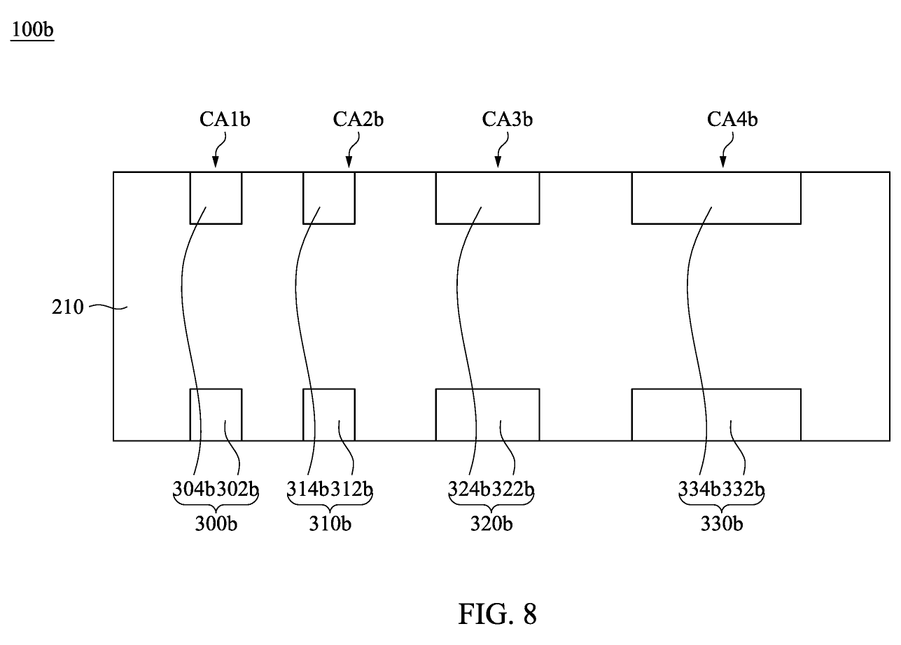

Referring to FIG. 8, is a schematic top view of an array type multi-layer ceramic capacitor 100b in accordance with a third embodiment of the present disclosure. The array type multi-layer ceramic capacitor 100b is substantially the same as the above array type multi-layer ceramic capacitor 100a. The difference between the array type multi-layer ceramic capacitor 100b and 100a is that numbers of internal electrodes of internal electrode sets of capacitor units CA1b and CA2b of the array type multi-layer ceramic capacitor 100b are the same, but different from numbers of internal electrodes of internal electrode sets of capacitor units CA3b and CA4b. In addition, the numbers of the internal electrodes of the internal electrode sets of the capacitor units CA3b and CA4b are different from each other.

In the present embodiment, pitches of first internal electrodes and second internal electrodes of the capacitor units CA1b, CA2b, CA3b, and CA4b are substantially the same. Numbers of the first internal electrodes and the second internal electrodes of the capacitor unit CA1b are the same as those of the capacitor unit CA2b, the numbers of the first internal electrodes and second internal electrodes of each of the capacitor units CA1b and CA2b are smaller than those of the capacitor unit CA3b, and the numbers of the first internal electrodes and the second internal electrodes of the capacitor unit CA3b are smaller than those of the capacitor unit CA4b. Therefore, widths of a first terminal electrode 302b and a second terminal electrode 304b of a terminal electrode pair 300b of the capacitor unit CA1b are substantially equal to those of a first terminal electrode 312b and a second terminal electrode 314b of a terminal electrode pair 310b of the capacitor unit CA2b, the widths of the first terminal electrode 312b and the second terminal electrode 314b of the capacitor unit CA2b are smaller than those of a first terminal electrode 322b and a second terminal electrode 324b of a terminal electrode pair 320b of the capacitor unit CA3b, and the widths of the first terminal electrode 322b and the second terminal electrode 324b of the capacitor unit CA3b are smaller than those of a first terminal electrode 332b and a second terminal electrode 334b of a terminal electrode pair 330b of the capacitor unit CA4b.

Furthermore, a capacitance value of the capacitor unit CA1b is substantially equal to that of the capacitor unit CA2b, the capacitance values of the capacitor units CA1b and CA2b are smaller than that of the capacitor unit CA3b, and the capacitance value of the capacitor unit CA3b is smaller than that of the capacitor unit CA4b.

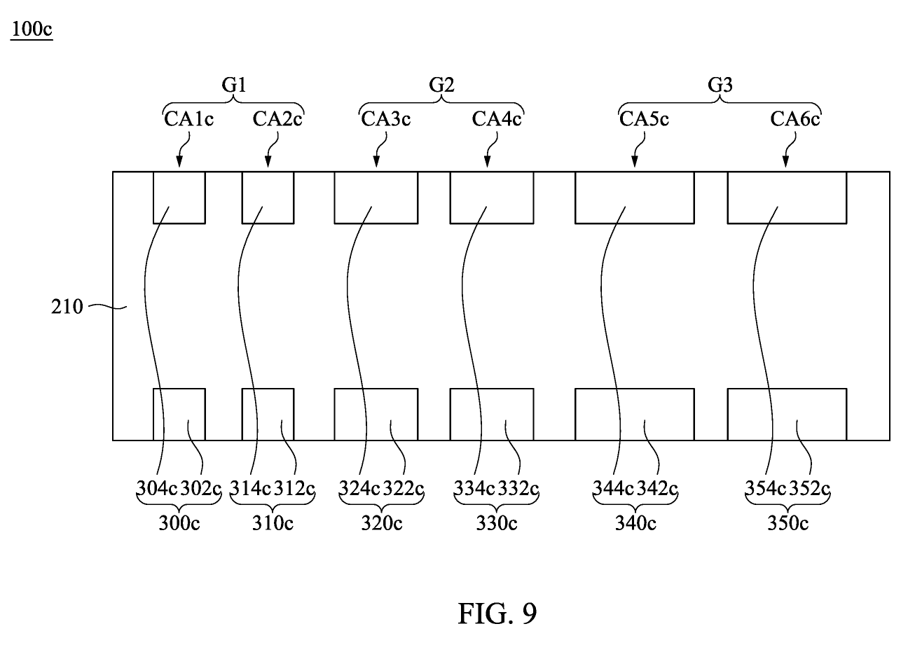

Referring to FIG. 9, FIG. 9 is a schematic top view of an array type multi-layer ceramic capacitor 100c in accordance with a fourth embodiment of the present disclosure. The array type multi-layer ceramic capacitor 100c is substantially the same as the above array type multi-layer ceramic capacitor 100b. The difference between the array type multi-layer ceramic capacitor 100c and 100b is that the array type multi-layer ceramic capacitor 100c is divided into groups G1 to G3. Each of the group G1 to G3 includes two or more capacitor units, and internal electrode sets of the capacitor units in each of the groups G1 to G3 include the same number of first internal electrodes and the same number of second internal electrodes.

In the example shown in FIG. 9, the group G1 includes capacitor units CA1c and CA2c, the group G2 includes capacitor units CA3c and CA4c, and the group G3 includes capacitor units CA5c and CA6c. The numbers of the first internal electrodes and the second internal electrodes of each internal electrode set of each of the capacitor units CA1c and CA2c of the group G1 are different from those of the first internal electrodes and the second internal electrodes of each internal electrode set of each of the capacitor units CA3c and CA4c of the group G2, and those of the first internal electrodes and the second internal electrodes of each internal electrode set of each of the capacitor units CA5c and CA6c of the group G3. In addition, the numbers of the first internal electrodes and the second internal electrodes of each internal electrode set of each of the capacitor units CA3c and CA4c of the group G2 are also different from those the first internal electrodes and the second internal electrodes of each internal electrode set of each of the capacitor units CA5c and CA6c of the group G3.

In the present embodiment, pitches of the first internal electrodes and second internal electrodes of the capacitor units CA1c, CA2c, CA3c, CA4c, AC5c, and CA6c are substantially the same. The numbers of the first internal electrodes and the second internal electrodes of each of the capacitor units CA1c and CA2c of the group G1 are smaller than those of each of the capacitor units CA3c and CA4c of the group G2, and the numbers of the first internal electrodes and the second internal electrodes of each of the capacitor units CA3c and CA4c of the group G2 are smaller than those of each of the capacitor units CA5c and CA6c of the group G3. Therefore, widths of a first terminal electrode 302c and a second terminal electrode 304c of a terminal electrode pair 300c of the capacitor unit CA1c and widths of a first terminal electrode 312c and a second terminal electrode 314c of a terminal electrode pair 310c of the capacitor unit CA2c are smaller than widths of a first terminal electrode 322c and a second terminal electrode 324c of a terminal electrode pair 320c of the capacitor unit CA3c and widths of a first terminal electrode 332c and a second terminal electrode 334c of a terminal electrode pair 330c of the capacitor unit CA4c. Furthermore, the widths of the first terminal electrode 322c and the second terminal electrode 324c of the terminal electrode pair 320c of the capacitor unit CA3c and the widths of the first terminal electrode 332c and the second terminal electrode 334c of the terminal electrode pair 330c of the capacitor unit CA4c are smaller than widths of a first terminal electrode 342c and a second terminal electrode 344c of a terminal electrode pair 340c of the capacitor unit CA5c and widths of a first terminal electrode 352c and a second terminal electrode 354c of a terminal electrode pair 350c of the capacitor unit CA6c.

Moreover, a capacitance value of the capacitor unit CA1c is substantially equal to that of the capacitor unit CA2c, a capacitance value of the capacitor unit CA3c is substantially equal to that of the capacitor unit CA4c, and a capacitance value of the capacitor unit CA5c is substantially equal to that of the capacitor unit CA6c. The capacitance values of the capacitor units CA1c and CA2c are smaller than those of the capacitor units CA3c and CA4c, and the capacitance values of the capacitor units CA3c and CA4c are smaller than those of the capacitor units CA5c and CA6c.

According to the above embodiments, the array type multi-layer ceramic capacitor of the present disclosure includes plural internal electrode sets, and three side surfaces of the first portion of each of the first internal electrodes and the second internal electrodes of each internal electrode set are exposed on the upper surface, the end surface, and the lower surface of the ceramic body. Therefore, based on the exposed portions of each of the internal electrode sets, terminal electrodes can be grown on the two end surfaces of the ceramic body and the areas of the upper surface and the lower surface adjacent to the two end surfaces by electroplating. The terminal electrodes of each of the internal electrode sets are formed by electroplating, such that the terminal electrodes of the capacitor units of the array type multi-layer ceramic capacitor can be formed simultaneously, thereby achieving the miniaturization of the array type multi-layer ceramic capacitor. In addition, the terminal electrodes grown by electroplating has low surface roughness and uniform thickness, which is beneficial to the application of the array type multi-layer ceramic capacitor in an embedded packaging structure.

Although the present disclosure has been disclosed above with embodiments, it is not intended to limit the present disclosure. Any person having ordinary skill in the art can make various changes and modifications without departing from the spirit and scope of the present disclosure. Therefore, the protection scope of the present disclosure should be defined by the scope of the appended claims.

What is claimed is:

1. An array type multi-layer ceramic capacitor, comprising:
a multi-layer brick comprising:
a ceramic body having an upper surface and a lower surface, and a first end surface and a second end surface that are opposite to each other, wherein the first end surface and the second end surface are located between the upper surface and the lower surface; and
a plurality of internal electrode sets embedded in the ceramic body and physically separated from each other, wherein each of the internal electrode sets comprises a plurality of first internal electrodes and a plurality of second internal electrodes, and in each of the internal electrode sets, the first internal electrodes and the second internal electrodes alternate with each other and are physically separated from each other, wherein the first internal electrodes extend from the first end surface toward the second end surface and are spaced apart from the second end surface, the second internal electrodes extend from the second end surface toward the first end surface and are spaced apart from the first end surface, and each of the first internal electrodes and the second internal electrodes comprises:
a first portion comprising a first side surface, a second side surface, a third side surface, and a fourth side surface connected in sequence, wherein the first side surface, the second side surface, and the third side surface are respectively exposed on the upper surface, the first end surface or the second end surface, and the lower surface; and
a second portion connected to the fourth side surface of the first portion, and the second portion being completely embedded in the ceramic body without being exposed; and
a plurality of terminal electrode pairs correspondingly disposed on the internal electrode sets and spaced apart from each other, wherein each of the terminal electrode pairs comprises a first terminal electrode and a second terminal electrode, wherein the first terminal electrode extends to cover the first side surfaces, the second side surfaces, and the third side surfaces of the first portions of the first internal electrodes of the corresponding internal electrode set, and the second terminal electrode extends to cover the first side surfaces, the second side surfaces, and the third side surfaces of the first portions of the second internal electrodes.

2. The array type multi-layer ceramic capacitor of claim 1, wherein numbers of the first internal electrodes of the internal electrode sets are the same, and numbers of the second internal electrodes of the internal electrode sets are the same.

3. The array type multi-layer ceramic capacitor of claim 1, wherein numbers of the first internal electrodes of the internal electrode sets are different from each other, and numbers of the second internal electrodes of the internal electrode sets are different from each other.

4. The array type multi-layer ceramic capacitor of claim 1, wherein numbers of the first internal electrodes in a portion of the internal electrode sets are the same, numbers of the second internal electrodes in the portion of the internal electrode sets are the same, and a number of the first internal electrodes and a number of the second internal electrodes in each of the other portion of the internal electrode sets are different from the portion of the internal electrode sets.

5. The array type multi-layer ceramic capacitor of claim 1, wherein the internal electrode sets are divided into a plurality of groups, and in each of the groups, numbers of the first internal electrodes of the internal electrode sets are the same and numbers of the second internal electrodes of the internal electrode sets are the same.

6. The array type multi-layer ceramic capacitor of claim 5, wherein each of the internal electrode sets of each of the groups and each of the internal electrode sets of any other of the groups comprise different numbers of the first internal electrodes and different numbers of the second internal electrodes.

7. The array type multi-layer ceramic capacitor of claim 1, wherein each of the first terminal electrode and the second terminal electrode of each of the terminal electrode pairs comprises an electroplated copper structure.

8. The array type multi-layer ceramic capacitor of claim 1, wherein each of the first internal electrodes and the second internal electrodes is in a T-like shape.

9. The array type multi-layer ceramic capacitor of claim 1, wherein each of the internal electrode sets, the corresponding terminal electrode pairs, and portions of the ceramic body between the corresponding terminal electrode pairs form a capacitor unit, and structures of the capacitor units are the same as each other.

10. The array type multi-layer ceramic capacitor of claim 1, wherein each of the internal electrode sets, the corresponding terminal electrode pairs, and portions of the ceramic body between the corresponding terminal electrode pairs form a capacitor unit, and structures of the capacitor units are different from each other.
